(19) United States
(12) Patent Application Publication
(10) Pub. No.: US 2022/0067325 A1
(43) Pub. Date: Mar. 3, 2022

(54) FINGERPRINT IDENTIFICATION MODULE AND DISPLAY DEVICE HAVING SAME

(71) Applicant: Visual-Sensing Technology Corp., Hsinchu (TW)

(72) Inventors: Wei-Hung Hsu, Hsinchu (TW); SHANG-YU YEH, Hsinchu (TW)

(21) Appl. No.: 17/198,656

(22) Filed: Mar. 11, 2021

(30) Foreign Application Priority Data
Sep. 1, 2020 (CN) 202010905462.3

(51) Int. Cl. G06K 9/00

(52) U.S. Cl. CPC G06K 9/0004; G06K 9/00046

(57) ABSTRACT

A fingerprint identification module is configured to identify fingerprint under a display screen. The fingerprint identification module includes an optical sensor configured to receive light reflected by a finger, at least two light-emitting elements surrounding the optical sensor, at least two first polarizers, a second polarizer, and at least two polarization rotators. Each first polarizer is on a light emitting surface of one light-emitting element. A polarization axis of the first polarizer and a polarization axis of the second polarizer is perpendicular to each other. Each polarization rotator is on a side of the first polarizer away from the light-emitting element.

### FIELD

The subject matter herein generally relates to a fingerprint identification module and a display device having the fingerprint identification module.

### BACKGROUND

For a display device having a fingerprint identification module under a display screen, an auxiliary light source is also set under the display screen for optical fingerprint detection to generate fingerprint images. Some components in the display screen, such as a reflector, may reflect a part of the light emitted by the auxiliary light source to an optical sensor, and the light becomes stray light when collecting fingerprint light signals. The stray light decreases the imaging quality of the optical sensor and affect the accuracy of fingerprint identification.

### BRIEF DESCRIPTION OF THE DRAWINGS

Implementations of the present technology will now be described, by way of embodiments only, with reference to the attached figures.

FIG. 1 is a cross-sectional view of a display device having a fingerprint identification module according to a first embodiment of the present disclosure.

FIG. 2 is a cross-sectional view of the display device including a backlight module.

FIG. 3 are plan views showing light-emitting elements surrounding an optical sensor.

FIG. 4 is a cross-sectional view of a display device having a fingerprint identification module according to a second embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

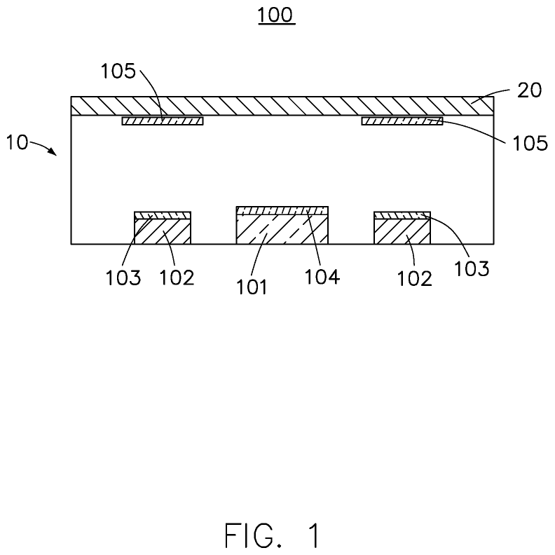

FIG. 1 illustrates a display device 100 of a first embodiment. The display device 100 includes a display screen 20 and a fingerprint identification module 10 under the display screen 20. When a fingertip touches the display screen 20 of the display device 100, the fingerprint identification module 10 will acquire a fingerprint image and can identify the fingerprint.

In this embodiment, the display screen 20 is a liquid crystal display and includes a color filter substrate (not shown), a thin film transistor (TFT) array substrate opposite to the color filter substrate, and a liquid crystal layer between the color filter substrate and the TFT array substrate. The display screen 20 also includes an upper polarizer (not show) on a side of the color filter substrate away from the liquid crystal layer and a lower polarizer (not shown) on a side of the TFT array substrate away from the liquid crystal layer.

As shown in FIG. 1, the fingerprint identification module 10 includes an optical sensor 101, at least two light-emitting elements 102, and a polarization rotator 105. The at least two light-emitting elements 102 are placed around the optical sensor 101. A light-emitting surface of each light-emitting element 102 is spaced apart from the display screen 20 and faces the display screen 20. A first polarizer 103 is provided on the light emitting surface of each light emitting element 102. The first polarizers 103 and the light-emitting elements 102 are arranged in one-to-one correspondence. A number of the first polarizers 103 is equal to a number of the light-emitting elements 102. The first polarizer 103 polarizes light emitted from the light-emitting element 102. A second polarizer 104 is located on the optical sensor 101 and is on a side of the optical sensor 101 adjacent to the display screen 20. A polarization axis of the first polarizer 103 and a polarization axis of the second polarizer 104 are perpendicular to each other. The polarization rotators 105 and the first polarizers 103 are arranged in one-to-one correspondence. A number of the polarization rotators 105 is equal to a number of the first polarizers 103. Each polarization rotator 105 is located on a side of the first polarizer 103 away from the light-emitting element 102. The polarization rotator 105 rotates polarized light passing through the first polarizer 103 facing the polarization rotator 105, and changes a polarization state of the polarized light. Each polarization rotator 105 is on an optical path of the polarized light from the first polarizer 103.

In this embodiment, the light-emitting elements 102 are used as an auxiliary light source emitting light outwards toward the finger for fingerprint detection, and the optical sensor 101 collects the light reflected by the finger to form a fingerprint image.

In this embodiment, the polarization rotator 105 is located between the display screen 20 and the first polarizer 103, and the second polarizer 104 is located between the optical sensor 101 and the display screen 20. Each polarization rotator 105 is spaced apart from the first polarizer 103 opposite to the polarization rotator 105. A distance between the polarization rotator 105 and the first polarizer 103 is not limited, as long as the polarized light from the first polarizer 103 can pass through the polarization rotator 105. In other embodiments, each polarization rotator 105 and the first polarizer 103 may be directly in contact with each other.

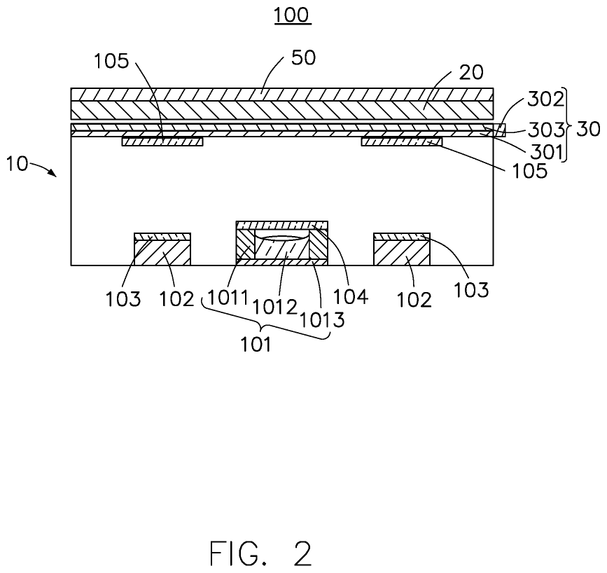

As shown in FIG. 2, the display device 100 further includes a backlight module 30 to provide the display screen 20 with light required for image display. The backlight module 30 is located between the display screen 20 and the fingerprint identification module 10. The backlight module 30 includes a reflective sheet 301 located on a side of the display screen 20 adjacent to the fingerprint identification module 10, a light guiding plate 303 between the reflective sheet 301 and the display screen 20, and a backlight source 302 on a side of the light guiding plate 303. The reflective sheet 301 reflects the light emitted from the backlight source 302, and the light guiding plate 303 guides the light emitted from the backlight source 302 towards the display screen. In this embodiment, each polarization rotator 105 is located on a side of the reflective sheet 301 away from the display screen 20. In one embodiment, each polarization rotator 105 may be attached to the side of the reflective sheet 301 away from the display screen 20.

In a traditional fingerprint identification module (not shown), when the emitted light is incident on a reflector, the light is reflected by the reflector, enters into the optical sensor, and becomes stray light when the optical sensor collects the light from the fingerprint, causing the fingerprint image to be blurred.

However, in this disclosure, the light from each light-emitting element 102 passes through the first polarizer 103 to become polarized light A having a specific polarization state. When a part of the polarized light A is reflected by the reflective sheet 301 to the second polarizer 104, the perpendicularity between the polarization axis of the second polarizer 104 and the polarization axis of the first polarizer 103 prevents the polarized light A passing through the second polarizer 104, to enter into the optical sensor 101. The second polarizer 104 and the first polarizer 103 cooperate to avoid blurred fingerprint images caused by stray light entering the optical sensor 101.

In this embodiment, the light-emitting surface of each light-emitting element 102 is covered by one first polarizer 103, so that as much as possible of the light emitted from each light-emitting element 102 becomes polarized light. The side of the optical sensor 101 that obtains the fingerprint light signals is covered by the second polarizer 104, so the light reflected by the finger enters into the second polarizer 104 and then enters into the optical sensor 101. In this way, the greatest possible amount of stray light is kept away from the optical sensor 101.

To ensure that the polarized light A passing through the display screen 20 and being reflected by the finger passes through the second polarizer 104 to enter into the optical sensor 101, the polarization rotator 105 is provided on a side of one first polarizer 103 away from the light-emitting element 102. The polarization rotator 105 rotates and thus changes polarization state of the polarized light A from the first polarizer 103, so that the polarized light A reflected by the finger can pass through the second polarizer 104 and enter into the optical sensor 101.

In this embodiment, the backlight module 30 further includes a diffusion sheet and a brightness enhancement sheet (not shown) stacked between the light guiding plate 303 and the display screen 20.

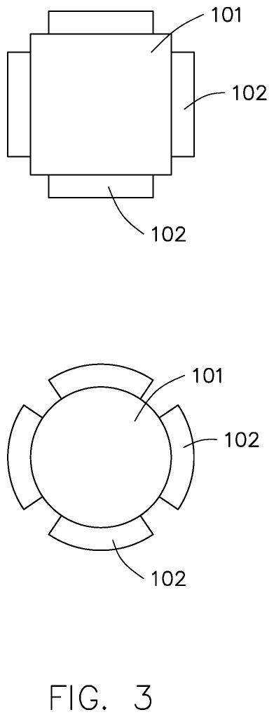

In this embodiment, each light-emitting element is a light-emitting diode (LED). Neither the distance, nor inclination angle, nor arrangement of each light-emitting element 102 between the optical sensor 101 is limited. The light-emitting elements 102 can be in a square arrangement, a circle, or in other arbitrary shapes around the optical sensor 101. FIG. 3 illustrates four light-emitting elements surrounding the optical sensor 101 to form a rectangular grid and a circle.

In this embodiment, each light-emitting element 102 can emit visible or invisible light. The first polarizer 103, the second polarizer 104, and the polarization rotator 105 are selected according to the wavelength of the light emitted from each light-emitting element 102. Specifically, when each light-emitting element 102 emits visible light, the first polarizer 103 and the second polarizer 104 are visible light polarizers, and the polarization rotator 105 is used to rotate the polarized light in the visible light wavelength range from the first polarizer 103 and change the polarization state of the polarized light. Herein, the polarization rotator 105 can be made of plastic, glass, or other transparent materials having birefringent properties. When each light-emitting element 102 emits invisible light, the first polarizer 103 and the second polarizer 104 are invisible light polarizers, and the polarization rotator 105 is used to rotate the polarized light within the wavelength range of the invisible light and change the polarization state of such polarized light. Herein, the polarization rotator 105 can be made of semiconductor material.

In one embodiment, the polarization rotator 105 may be a half-wave plate. The first polarizer 103 and the second polarizer 104 may be metal wire grid polarizers, and a distance between adjacent tooth-like structures in the grids of the metal wire grid polarizer is in a range from 50 nm to 250 nm. The duty ratio of the tooth-like structures in the grids is in a range from 0.2 to 0.6. As shown in FIG. 2, the optical sensor 101 further includes a lens barrel 1011, a lens 1012 in the lens barrel 1011, and a sensor chip 1013 located on a side of the lens barrel 1011 away from the second polarizer 104. The second polarizer 104 is located on the side of the lens barrel 1011 away from the sensor chip 1013 and faces the lens 1012. The lens barrel 1011 fixes the lens 1012 in place, the lens 1012 is used to converge fingerprint light. The sensor chip 1013 is used to perform imaging according to the fingerprint light as signals converged by the lens 1012.

In one embodiment, the second polarizer 104 is located above the lens barrel 1011, and the second polarizer 104 covers the lens barrel 1011, so that the light enters into the optical sensor 101 after passing through the second polarizer 104.

In this embodiment, the lens 1012 includes at least one lens (not shown). The sensor chip 1013 may be, but is not limited to, an optical fingerprint sensor. The sensor chip 1013 may be a sensor array (not shown) having a plurality of optical sensor units. In this case, the lens 1012 is a microlens array having a plurality of microlenses, and the microlens array is located above the sensor chip 1013. Each microlens corresponds to and is aligned with one optical sensor unit.

As shown in FIG. 2, the display device 100 further includes a cover plate 50 on the side of the display screen 20 away from the backlight module 30, the cover plate 50 covers and protects the display screen 20. The cover plate 50 is transparent. Touching the display device 300 with a human finger actually means pressing on the cover plate 50 with a finger.

In this embodiment, the display device 100 further includes a circuit board (not shown) on the side of the optical sensor 101 away from the second polarizer 104. The optical sensor 101 can be soldered to the circuit board by soldering pads, and electrical interconnection and signal transmission between the optical sensor 101 and other elements of the display device 300 can be realized by the circuit board. The circuit board may be a flexible printed circuit (FPC).

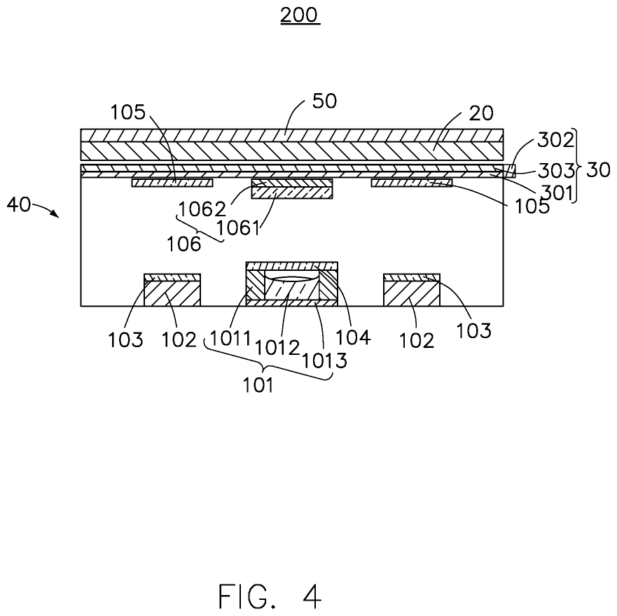

FIG. 4 illustrates a display device 200 of a second embodiment of the present disclosure. The display device 200 is substantially the same as the display device 100 and includes a display screen 20, a backlight module 23, and a fingerprint identification module 40 under the display screen 20.

As shown in FIG. 4, the fingerprint identification module 40 also includes an optical sensor 101, at least two light-emitting elements 102, first polarizers 103, a second polarizer 104, and a polarization rotator 105. The fingerprint identification module 40 further includes a polarizer group 106.

The polarizer group 106 is arranged to be opposite to the second polarizer 104 and is located on the side of the second polarizer 104 away from the optical sensor 101. The polarizer group 106 includes a third polarizer 1061 and a fourth polarizer 1062 stacked in a thickness direction of the polarizer group 106. A polarization axis of the third polarizer 1061 is perpendicular to a polarization axis of the fourth polarizer 1062. In this embodiment, respective positions of the third polarizer 1061 and the fourth polarizer 1062 can be changed, and the third polarizer 1061 and the fourth polarizer 1062 can be attached together or not together, as long as the respective polarization axes of the third and fourth polarizers 1061 and 1062 are perpendicular to each other. An orthographic projection of the third polarizer 1061 on the fourth polarizer 1062 covers the fourth polarizer 1062 at least in part.

In this embodiment, the polarizer group 106 and the second polarizer 104 are spaced apart from each other. The polarizing group 106 is located on the side of the reflective sheet 301 away from the display screen 20, and the polarizing group 106 can be attached to the reflective sheet 301. A distance between the polarizer group 106 and the second polarizer 104 is not limited, as long as the light passed through the polarizer group 106 can be transmitted to the second polarizer 104. In other embodiments, the polarizer group 106 and the second polarizer 104 may also be arranged to be in direct contact with each other, according to actual conditions.

In this embodiment, each light-emitting element 102 is a near-infrared light-emitting diode. Both the first polarizer 103 and the second polarizer 104 are near-infrared light polarizers and the polarization rotator 105 is made of semiconductor material. The third polarizer 1061 and the fourth polarizer 1062 are both visible light polarizers. Herein, the polarizer group 106 formed by the third polarizer 1061 and the fourth polarizer 1062 can only polarize visible light, the near-infrared light emitted by each light-emitting element 102 cannot be polarized, or repolarized, by the polarizer group 106. In other embodiments, each light-emitting element 102 may emit invisible light in other wavelength ranges.

In this embodiment, the third polarizer 1061 and the fourth polarizer 1062 may be visible light polarizers composed of absorbent polymer materials or visible light polarizers composed of birefringent materials, not being limited thereto.

The aforementioned fingerprint identification module 10 does not include the polarizer group 106, when the display screen 20 is in a bright state, the light emitted by the backlight source 302 of the display screen 20 will pass through the reflective sheet 301, and the optical sensor 101 under the display screen 20 will receive all the light, not only the light emitted by the light-emitting element 102 and reflected by the finger but also the light emitted by the backlight source 302 of the display screen 20. This will cause the fingerprint image to be blurred or overexposed. However, in the fingerprint identification module 40, the third polarizer 1061 and the fourth polarizer 1062 attenuate the light emitted by the backlight source 302 to a level less than 0.005% of its original strength. Therefore, the light emitted by the backlight source 302 of the display screen 20 is prevented from entering the optical sensor 101.

In this embodiment, when same visible light polarizers are used, the near-infrared light emitted from each light-emitting element 102 can pass through the visible light polarizer (the first polarizer 103 and the second polarizer 104) and the light transmittance can reach more than 90% of original. Under the same illuminance, the intensity of the near-infrared light received by the optical sensor 101 differs from the intensity of the visible light received by the optical sensor 101 by 4 to 5 levels of magnitude (the difference in intensity between the near-infrared light and the visible light is 10⁴ to 10⁵). The use of light-emitting elements 102 which emit near-infrared light effectively improves the efficiency of fingerprint identification module 40 in detecting fingerprint images.

In one embodiment, the third polarizer 1061 and the fourth polarizer 1062 are arranged opposite to each other, and sizes of the third polarizer 1061 and the fourth polarizer 1062 are the same, ensuring that the amount of light respectively passing through the third and fourth polarizers 1061 and 1062 is the same. An orthographic projection of the polarizer group 106 on the second polarizer 104 completely covers the second polarizer 104. In this way, there is very little light from the backlight source 302 which does not pass through the polarizer group 106 before entering the optical sensor 101, this effectively suppresses blurring and overexposure of fingerprint images caused by the backlight source 302.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A fingerprint identification module under a display screen, configured to identify fingerprint, the fingerprint identification module comprising:
an optical sensor configured to receive light reflected by a finger touching on the display screen;
at least two light-emitting elements surrounding the optical sensor;
at least two first polarizers, each of the at least two first polarizers being on a light emitting surface of one of the at least two light-emitting elements;
a second polarizer on a side of the optical sensor receiving the light reflected by the finger, a polarization axis of the first polarizer and a polarization axis of the second polarizer being perpendicular to each other;
at least two polarization rotators, each of the at least two polarization rotators being on a side of one of the at least two first polarizers away from the light-emitting element; the polarization rotator configured to rotate polarized light passing through the first polarizer and change a polarization state of the polarized light.

2. The fingerprint identification module of claim 1, wherein each of the at least two light-emitting elements is configured to emit visible light; the at least two first polarizers and the second polarizer are visible light polarizers.

3. The fingerprint identification module of claim 1, wherein each of the at least two light-emitting elements is configured to emit invisible light; the at least two first polarizers and the second polarizer are invisible light polarizers.

4. The fingerprint identification module of claim 3, further comprising a polarizer group; wherein the polarizer group is arranged opposite to the second polarizer and is located on a side of the second polarizer away from the optical sensor; the polarizer group comprises a third polarizer and a fourth polarizer stacked in a thickness direction of the polarizer group; a polarization axis of the third polarizer is perpendicular to a polarization axis of the fourth polarizer.

5. The fingerprint identification module of claim 4, wherein each of the at least two light-emitting elements is configured to emit near-infrared light; the at least two first polarizers and the second polarizer are near-infrared light polarizers; both the third polarizer and the fourth polarizer are visible light polarizers.

6. The fingerprint identification module of claim 5, wherein a size of the third polarizer and a size of the fourth polarizer are the same; an orthographic projection of the polarizer group on the second polarizer completely covers the second polarizer.

7. The fingerprint identification module of claim 1, wherein the at least two first polarizers and the second polarizer are metal wire grid polarizers.

8. The fingerprint identification module of claim 1, wherein each of the at least two polarization rotators is a half-wave plate.

9. The fingerprint identification module of claim 1, wherein the optical sensor comprises a lens barrel, a lens in the lens barrel, and a sensor chip located on a side of the lens barrel away from the second polarizer; the second polarizer is located on a side of the lens barrel away from the sensor chip and faces the lens; the lens is configured to converge fingerprint light signals, and the sensor chip is configured to perform imaging according to the fingerprint light signals converged by the lens.

10. A display device, comprising:
a display screen;
a backlight module stacked on a side of the display screen; and
a fingerprint identification module on a side of the backlight module away from the display screen, the fingerprint identification module comprising:
an optical sensor configured to receive light reflected by a finger touching on the display screen;
at least two light-emitting elements surrounding the optical sensor;
at least two first polarizers, each of the at least two first polarizers being on a light emitting surface of one of the at least two light-emitting elements;
a second polarizer on a side of the optical sensor receiving the light reflected by the finger, a polarization axis of the first polarizer and a polarization axis of the second polarizer being perpendicular to each other;
at least two polarization rotators, each of the at least two polarization rotators being on a side of the first polarizer away from the light-emitting element; the polarization rotator configured to rotate polarized light passing through the first polarizer and change a polarization state of the polarized light.

11. The display device of claim 10, wherein each of the at least two light-emitting elements is configured to emit visible light; the at least two first polarizers and the second polarizer are visible light polarizers.

12. The display device of claim 10, wherein each of the at least two light-emitting elements is configured to emit invisible light; the at least two first polarizers and the second polarizer are invisible light polarizers.

13. The display device of claim 12, further comprising a polarizer group; wherein the polarizer group is arranged opposite to the second polarizer and is located on a side of the second polarizer away from the optical sensor; the polarizer group comprises a third polarizer and a fourth polarizer stacked in a thickness direction of the polarizer group; a polarization axis of the third polarizer is perpendicular to a polarization axis of the fourth polarizer.

14. The display device of claim 13, wherein each of the at least two light-emitting elements is configured to emit near-infrared light; the at least two first polarizers and the second polarizer are near-infrared light polarizers; the third polarizer and the fourth polarizer are visible light polarizers.

15. The display device of claim 14, wherein a size of the third polarizer and a size of the fourth polarizer are the same; an orthographic projection of the polarizer group on the second polarizer completely covers the second polarizer.

16. The display device of claim 10, wherein the at least two first polarizers and the second polarizer are metal wire grid polarizers.

17. The display device of claim 10, wherein each of the at least two polarization rotators is a half-wave plate.

18. The display device of claim 10, wherein the optical sensor comprises a lens barrel, a lens in the lens barrel, and a sensor chip located on a side of the lens barrel away from the second polarizer; the second polarizer is located on a side of the lens barrel away from the sensor chip and faces the lens; the lens is configured to converge fingerprint light signals, and the sensor chip is configured to perform imaging according to the fingerprint light signals converged by the lens.
